(19) United States
(12) Patent Application Publication
(10) Pub. No.: US 2008/0232399 A1
(43) Pub. Date: Sep. 25, 2008

(54) SYSTEM AND METHOD FOR MODIFYING PARAMETERS OF AN AIR LINK

(76) Inventors: Rejean Groleau, Ville St-Laurent (CA); Robert Buchnajzer, Montreal (CA)

Correspondence Address: HOLLAND & KNIGHT LLP, 10 ST. JAMES AVENUE, 11th Floor, BOSTON, MA, 02116-3889, US

(21) Appl. No.: 11/689,849

(22) Filed: Mar. 22, 2007

(51) Int. Cl. H04J 3/16; H04J 3/22

(52) U.S. Cl. 370/468

(57) ABSTRACT

A method, computer program product and electronic device for adjusting a conversion parameter (C^{ss}ᵢ) associated with an individual user of a multi-user air link in response to, at least in part, a variation in the transmission quality of the air link. A bandwidth transmission rate (NIRᵢ) is determined for the individual user of the multi-user air link, such that the bandwidth transmission rate (NIRᵢ) is dependant upon the conversion parameter (C^{ss}ᵢ) associated with the individual user and a bandwidth distribution parameter (pᵢ) associated with the individual user. The bandwidth transmission rate (NIRᵢ) is compared with a target bandwidth requirement for the individual user of the multi-user air link. The bandwidth distribution parameter (pᵢ) associated with the individual user is adjusted to set the bandwidth transmission rate (NIRᵢ) essentially equal to the target bandwidth requirement.

### TECHNICAL FIELD

This disclosure relates to air links and, more particularly, to the modification of parameters controlling the transmission of data across air links.

### BACKGROUND

An air link (e.g., a wireless communication channel) is the connection between a client and a base station (BS)/access point (AP). Air links have a finite amount of bandwidth that is available to transmit data to users of the air link. Typically, the bandwidth of an air link is apportioned among various users of the air link. For example, an air link designed to service one hundred simultaneous users may simply apportion one percent of the bandwidth of the air link to each of its one hundred users. For various reasons, the data transmission rate across an air link may need to be adjusted due to changes in the quality of the air link. For example, the signal-to-noise ratio (i.e., SNR) of an air link may be monitored (e.g., to gauge to quality of the air link) and, in the event of a decrease in SNR, the data transmission rate of the channel may need to be reduced. Conversely, an increase in SNR may allow for a higher data transmission rate to be used on the air link.

Various environmental factors (e.g., distance between devices, weather conditions, electromagnetic interference, and line-of-sight obstructions) may contribute to changes in the quality of an air link. Accordingly, in certain environmental conditions, a 10.00 megabits per second air link may be reduced to a 2.00 megabits per second air link. Unfortunately, certain users may have minimum bandwidth requirements. For example, a Voice-over-IP (i.e., VoIP) user may have higher bandwidth requirements and stricter latency requirements. Accordingly, if (as discussed above) the bandwidth of the air link is equally-distributed among one hundred users and (e.g., due to environmental conditions) the total bandwidth of the air link drops from 10.00 megabits per second to 2.00 megabits per second, the resulting allocated bandwidth per user may drop from 100.00 kilobits per second to 20.00 kilobits per second. If the VoIP user requires an absolute minimum of 50.00 kilobits per second for acceptable voice quality, this reduction in allocated bandwidth may render the quality of the VoIP connection unacceptable.

### SUMMARY OF THE DISCLOSURE

In one implementation, a method includes adjusting a conversion parameter (C^{ss}ᵢ) associated with an individual user of a multi-user air link in response to, at least in part, a variation in the transmission quality of the air link. A bandwidth transmission rate (NIRᵢ) is determined for the individual user of the multi-user air link, such that the bandwidth transmission rate (NIRᵢ) is dependant upon the conversion parameter (C^{ss}ᵢ) associated with the individual user and a bandwidth distribution parameter (pᵢ) associated with the individual user. The bandwidth transmission rate (NIRᵢ) is compared with a target bandwidth requirement for the individual user of the multi-user air link. The bandwidth distribution parameter (pᵢ) associated with the individual user is adjusted to set the bandwidth transmission rate (NIRᵢ) essentially equal to the target bandwidth requirement.

One or more of the following features may also be included. The conversion parameter (C^{ss}ᵢ) may define the number of tones required to transmit one unit of data. The bandwidth transmission rate (NIRᵢ) may define the number of units of data to be transmitted per unit time. The bandwidth distribution parameter (pᵢ) associated with the individual user may be essentially equal to the product of the conversion parameter (C^{ss}ᵢ) associated with the individual user and the bandwidth transmission rate (NIRᵢ) determined for the individual user divided by a total bandwidth capacity of the air link.

The individual user may be one of a plurality of users. Each of the plurality of users may be assigned one of a plurality of bandwidth distribution parameters (pᵢ). The plurality of bandwidth distribution parameters may be summed to define a utilization factor for the multi-user air link. One or more of the plurality of bandwidth distribution parameters (pᵢ) may be reduced to reduce the utilization factor to less than or equal to 100%.

In another implementation, a computer program product resides on a computer readable medium and has a plurality of instructions stored on it which, when executed by a processor, cause the processor to perform operations including adjusting a conversion parameter (C^{ss}ᵢ) associated with an individual user of a multi-user air link in response to, at least in part, a variation in the transmission quality of the air link. A bandwidth transmission rate (NIRᵢ) is determined for the individual user of the multi-user air link, such that the bandwidth transmission rate (NIRᵢ) is dependant upon the conversion parameter (C^{ss}ᵢ) associated with the individual user and a bandwidth distribution parameter (pᵢ) associated with the individual user. The bandwidth transmission rate (NIRᵢ) is compared with a target bandwidth requirement for the individual user of the multi-user air link. The bandwidth distribution parameter (pᵢ) associated with the individual user is adjusted to set the bandwidth transmission rate (NIRᵢ) essentially equal to the target bandwidth requirement.

One or more of the following features may also be included. The conversion parameter (C^{ss}ᵢ) may define the number of tones required to transmit one unit of data. The bandwidth transmission rate (NIRᵢ) may define the number of units of data to be transmitted per unit time. The bandwidth distribution parameter (pᵢ) associated with the individual user may be essentially equal to the product of the conversion parameter (C^{ss}ᵢ) associated with the individual user and the bandwidth transmission rate (NIRᵢ) determined for the individual user divided by a total bandwidth capacity of the air link.

The individual user may be one of a plurality of users. Each of the plurality of users may be assigned one of a plurality of bandwidth distribution parameters (pᵢ). The plurality of bandwidth distribution parameters may be summed to define a utilization factor for the multi-user air link. One or more of the plurality of bandwidth distribution parameters (pᵢ) may be reduced to reduce the utilization factor to less than or equal to 100%.

In another implementation, an electronic device is configured for adjusting a conversion parameter (C^{ss}ᵢ) associated with an individual user of a multi-user air link in response to, at least in part, a variation in the transmission quality of the air link. A bandwidth transmission rate (NIRᵢ) is determined for the individual user of the multi-user air link, such that the bandwidth transmission rate (NIRᵢ) is dependant upon the conversion parameter (C^{ss}ᵢ) associated with the individual user and a bandwidth distribution parameter (pᵢ) associated with the individual user. The bandwidth transmission rate (NIRᵢ) is compared with a target bandwidth requirement for the individual user of the multi-user air link. The bandwidth distribution parameter (pᵢ) associated with the individual user is adjusted to set the bandwidth transmission rate (NIRᵢ) essentially equal to the target bandwidth requirement.

One or more of the following features may also be included. The conversion parameter (C^{ss}ᵢ) may define the number of tones required to transmit one unit of data. The bandwidth transmission rate (NIRᵢ) may define the number of units of data to be transmitted per unit time. The bandwidth distribution parameter (pᵢ) associated with the individual user may be essentially equal to the product of the conversion parameter (C^{ss}ᵢ) associated with the individual user and the bandwidth transmission rate (NIRᵢ) determined for the individual user divided by a total bandwidth capacity of the air link.

The individual user may be one of a plurality of users. Each of the plurality of users may be assigned one of a plurality of bandwidth distribution parameters (pᵢ). The plurality of bandwidth distribution parameters may be summed to define a utilization factor for the multi-user air link. One or more of the plurality of bandwidth distribution parameters (pᵢ) may be reduced to reduce the utilization factor to less than or equal to 100%.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a parameter modification system coupled to a distributed computing network;

FIG. 2 is a diagrammatic view of a plurality of wireless couplings included within an air link; and

FIG. 3 is a flow chart of a process executed by the parameter modification system of FIG. 1.

### DETAILED DESCRIPTION OF THE PREFERRED EMBODIMENTS

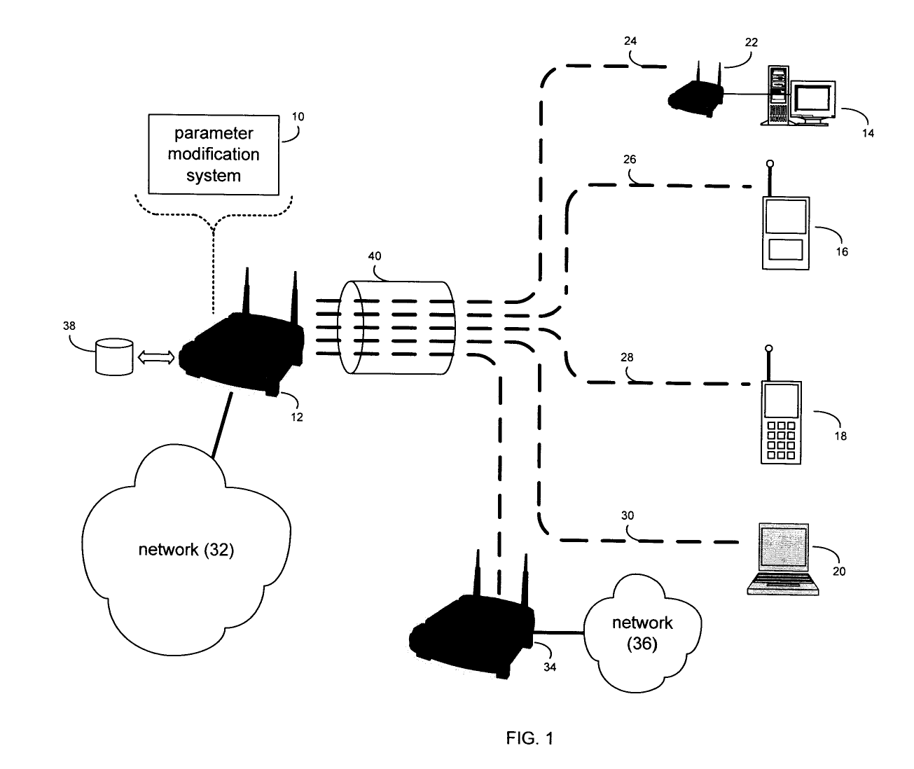

Referring to FIG. 1, there is shown a parameter modification system 10 for modifying the parameters of an air link between e.g., a wireless access point 12 and a plurality of wireless devices 14, 16, 18, 20, examples of which include a computer 14 (coupled to a wireless transceiving device 22), a wireless personal digital assistant (PDA) 16, a data-enabled cellular telephone 18, and a notebook computer 20 (which includes a wireless transceiving device, not shown).

During operation, wireless access point 12 may establish a plurality of wireless couplings 24, 26, 28, 30 between wireless access point 12 and the plurality of wireless devices 14, 16, 18, 20 respectively. While four wireless couplings (i.e., 24, 26, 28, 30) are shown in FIG. 1, this is for illustrative purposes only and is not intended to limit the scope of this disclosure. Various standards may govern and/or control the transmission of data across wireless couplings 24, 26, 28, 30, examples of which may include but are not limited to IEEE 802.11a, IEEE 802.11b, and IEEE 802.11g.

Wireless couplings 24, 26, 28, 30 may be bidirectional coupling that enable bidirectional communication between wireless access point 12 and the plurality of wireless devices (e.g., wireless devices 14, 16, 18, 20). Wireless access point 12 may be coupled to one or more distributed computing networks (e.g., network 32), examples of which may include but are not limited to the internet, an intranet, a local area network, and a wide area network.

Additionally/alternatively, wireless access point 12 may enable the wireless coupling of wireless point 12 and e.g., wireless gateway 34, thus providing for the wireless coupling of e.g., network 32 and network 36.

The instruction sets and subroutines of parameter modification system 10, which are typically stored on a storage device 38 coupled to wireless access point 12, are executed by one or more processors (not shown) and one or more memory architectures (not shown) incorporated into wireless access point 12. Storage device 38 may, by way of example, include but is not limited to a hard disk drive, a tape drive, an optical drive, a RAID array, a random access memory (RAM), or a read-only memory (ROM).

The total bandwidth capacity 40 of the air link established by wireless access point 12 may be apportioned among the plurality of wireless couplings 24, 26, 28, 30 (and, therefore, among the plurality of wireless devices 14, 16, 18, 20). For example, an air link having a total bandwidth capacity of 1.00 megabit per second link may be configured to service one hundred simultaneous users/devices, such that each user/device is apportioned a 100.00 kilobit per second wireless coupling. Each user/device need not be given an equal apportionment of the total bandwidth capacity of the air link. For example, a low bandwidth device (e.g., data-enabled cellular telephone 18) may be apportioned a 10.00 kilobit per second data transfer connection, while a high bandwidth device (e.g., wireless gateway 34) may be apportioned a 1.00 megabit per second data transfer connection. Total bandwidth capacity of an air link may be expressed/defined by the number of tones per second (to be discussed below) transmittable across the air link, an example of which is an air link having a total bandwidth capacity of 10.00 megatones per second. Additionally, the total bandwidth capacity of the air link may be apportioned based on the distribution of tones amongst the wireless couplings within the air link. For example, in a 10.00 megatone per second air link, each of the four wireless couplings 24, 26, 28, 30 may be apportioned e.g., 2.50 megatones per second.

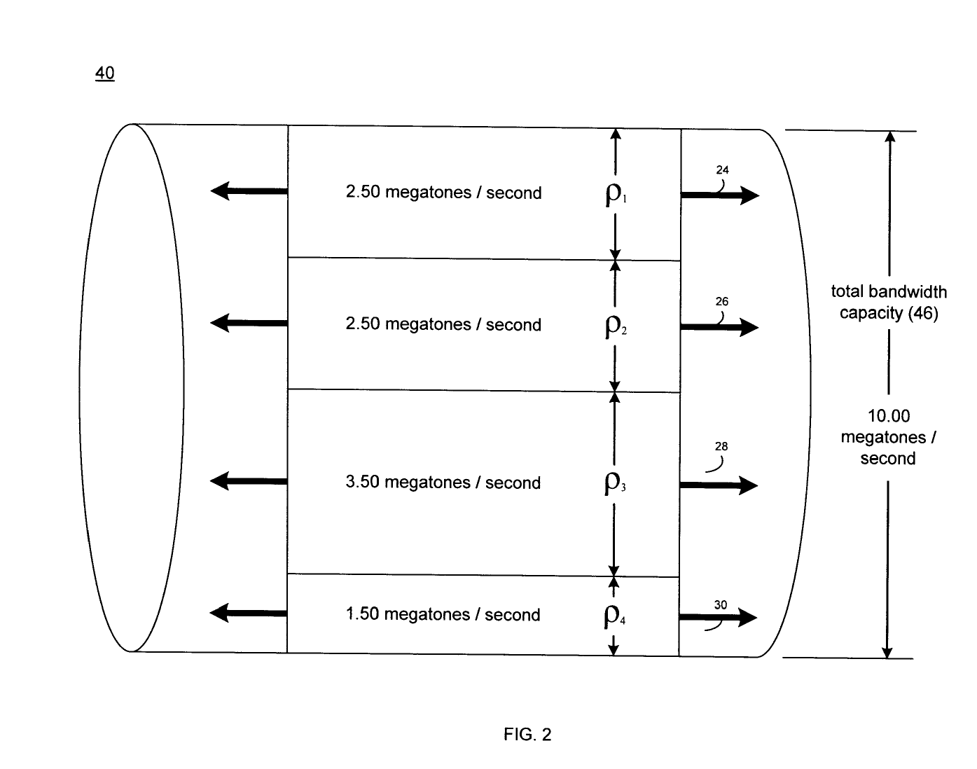

The sum of the individual apportionments typically should not exceed the total bandwidth capacity 40 of e.g., the air link established by wireless access point 12. Referring also to FIG. 2 and as discussed above, total bandwidth capacity 40 of the air link may be divided among the various users/devices of wireless access point 12. For example, assume that the air link established by wireless access point 12 has a total bandwidth capacity 40 of 10.00 megatones per second. This 10.00 megatones per second total bandwidth capacity may be apportioned amongst wireless couplings 24, 26, 28, 30. When apportioning the total bandwidth capacity 40 of an air link, the apportionment may be based on percentages. For example, wireless coupling 24 may be apportioned 25% of the total bandwidth capacity (indicated as bandwidth distribution parameter pᵢ) for an apportioned capacity of 2.50 megatones per second; wireless coupling 26 may be apportioned 25% of the total bandwidth capacity (indicated as bandwidth distribution parameter p₂) for an apportioned capacity of 2.50 megatones per second; wireless coupling 28 may be apportioned 35% of the total bandwidth capacity (indicated as bandwidth distribution parameter p₃) for an apportioned capacity of 3.50 megatones per second; and wireless coupling 30 may be apportioned 15% of the total bandwidth capacity (indicated as bandwidth distribution parameter p₄) for an apportioned capacity of 1.50 megatones per second.

When calculating a bandwidth distribution parameter (e.g., p₁), the following formula may be used:

pᵢ=[C^{ss}ᵢ×NIRᵢ/BWₜₒₜ

wherein pᵢ is the bandwidth distribution parameter; C^{ss}ᵢ is a conversion parameter (to be discussed below); NIRᵢ is bandwidth transmission rate (to be discussed below); and BWₜₒₜ is the total bandwidth capacity (e.g., 10.00 megatones per second) of the air link.

Various environmental conditions may result in a reduction in the quality of an air link. For example, electromagnetic interference, heavy rain, the distance of the air link, and physical line-of-sight obstructions may all contribute to an overall reduction in the quality of an air link. Various methodologies may be employed to determine the quality of an air link, such as monitoring the signal-to-noise ratio of the air link. In the event that the quality of the air link is high (e.g., has a comparatively high signal-to-noise ratio), a more-efficient C^{ss}ᵢ conversion parameter (to be discussed below) may be used, resulting in a more-efficient transfer of data. Conversely, if the quality of the air link is low (e.g., has a comparatively low signal-to-noise ratio), a less-efficient C^{ss}ᵢ conversion parameter (to be discussed below) may be used, resulting in a less-efficient transfer of data.

The C^{ss}ᵢ conversion parameter may define the number of tones required for an air link to transmit e.g., one bit of data. Typically, the C^{ss}ᵢ conversion parameter will vary depending on the type of modulation scheme employed for the air link (or a specific wireless coupling within the air link). The following table defines various modulation schemes/coding rates for orthogonal frequency-division multiplexing, and the C^{ss}ᵢ conversion parameter associated with each:

| Modulation Scheme | Coding Rate | C^{ss}ᵢ |
|---|---|---|
| BPSK | 1/2 | 2 |
| QPSK | 1/2 | 1 |
| QPSK | 3/4 | 2/3 |
| 16-QAM | 1/2 | 1/2 |
| 16-QAM | 3/4 | 1/3 |
| 64-QAM | 2/3 | 1/4 |
| 64-QAM | 3/4 | 2/9 |

Accordingly, 2/9^{ths} of a tone is required to transmit one bit of data across an air link using 64-QAM (¾). Conversely, two tones are required to transmit one bit of data across an air link using BPSK (½). Accordingly, 64-QAM (¾) is nine times more efficient than BPSK (½), as nine times the number of bits may be transferred (using 64-QAM (¾) versus BPSK (½)) using a fixed number of tones transmitted across an air link. For example, ten tones may transmit forty-five bits using 64-QAM (¾), while the same ten tones may only transmit five bits using BPSK (½).

As discussed above, when the quality of an air link (or a specific wireless coupling within the air link) increases, a more-efficient C^{ss}ᵢ conversion parameter (e.g., the C^{ss}ᵢ conversion parameter of 64-QAM (¾)) may be used, resulting in higher data transfer rates. Conversely, when the quality of the air link decreases, a less-efficient C^{ss}ᵢ conversion parameter (e.g., the C^{ss}ᵢ conversion parameter of BPSK (½)) may be used, resulting in lower data transfer rates.

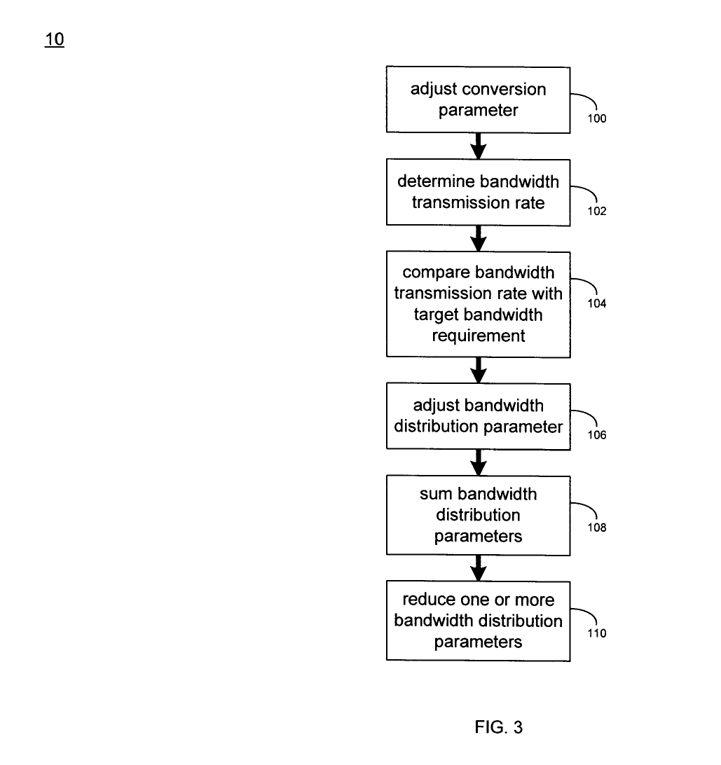

Referring also to FIG. 3, wireless access point 12 may monitor the quality of the air link (or a specific wireless coupling within the air link). As discussed above, this may involve determining a signal-to-noise ratio for the air link (or a specific wireless coupling within the air link). In the event that the quality of the air link changes, parameter modification system 10 may adjust 100 the conversion parameter (C^{ss}ᵢ) associated with the air link (or a wireless coupling within the air link). As discussed above, in the event that the quality of the air link (or a wireless coupling within the air link) improves, a more efficient modulation scheme and C^{ss}ᵢ conversion parameter (e.g., 64-QAM (¾)) may be used. Alternatively, in the event that the quality of the air link (or a wireless coupling within the air link) degrades, a less efficient modulation scheme and C^{ss}ᵢ conversion parameter (e.g., BPSK (½)) may be used.

However and as discussed above, certain wireless couplings (e.g., wireless coupling 28) may require that a high bandwidth connection be maintained. Accordingly, in the event that e.g., wireless coupling 28 is switched from 64-QAM (¾) modulation to BPSK (½) modulation due to a decrease in air link quality, the amount of data transferred (using an equivalent amount of tones) decreases by a factor if nine. In the event that e.g., wireless coupling 28 is sensitive to decreases in bandwidth (and the increased data latency that may result), wireless coupling 28 may no longer be capable of providing the necessary data throughput.

Accordingly, for each of the wireless coupling 24, 26, 28, 30 maintained by wireless access point 12, a target bandwidth requirement may be established. For example, assume that e.g., wireless coupling 28 requires a minimum data transfer rate of 1.00 megabit per second. To transmit 1.00 megabit of data per second using 64-QAM (¾) modulation, 222,222 tones per second are required. In the event that the air link established by wireless access point 12 is capable of providing 5,000,000 tones per second, 222,222 tones per second represents 4.4% of the total capacity of the air link. However, if (due to a decrease in air link quality) 64-QAM (¾) modulation is switched to BPSK (½) modulation, to transmit 1.00 megabit of data per second using BPSK (½) modulation, 2,000,000 tones per second are required. For the same 5,000,000 tones per second air link, 2,000,000 tones per second represents 40.00% of the total capacity of the air link. Accordingly, in the event that bandwidth distribution parameters p₁, p₂, p₃, p₄ (i.e., the apportionments of the total bandwidth capacity 40 of an air link) are rigidly maintained, the data transfer rates of individual wireless couplings within the air link may be adversely affected during time of low link quality. This, in turn, may result in the individual wireless couplings falling below their target bandwidth requirements.

Accordingly, parameter modification system 10 may determine 102 a bandwidth transmission rate (NIRᵢ) for one or more of the wireless couplings (e.g., wireless couplings 24, 26, 28, 30) within the air link. For example and as discussed above, wireless coupling 30 is apportioned a bandwidth distribution parameter p₄ of 1.50 megatones per second. For 64-QAM (¾) modulation, parameter modification system 10 may determine 102 that 1.50 megatones per second results in a data transfer rate of 6.75 megabits per second (i.e., the NIRᵢ). However, for BPSK (½) modulation, parameter modification system 10 may determine 102 that the same 1.50 megatones per second only results in 0.75 megabits per second (i.e., the NIRᵢ).

Accordingly, whenever the conversion parameter (C^{ss}ᵢ) of a particular wireless coupling is adjusted 100, parameter modification system 10 determines 102 the NIRᵢ for the impacted wireless link. Once the NIRᵢ is determined 102, the bandwidth transmission rate (NIRᵢ) is compared 104 with the target bandwidth requirement for the particular wireless coupling. Continuing with the above-stated example, assume that wireless coupling 30 is apportioned 1.50 megatones per second and, due to its use of BPSK (½) modulation, is only capable of a data transfer rate of 0.75 megabits per second (i.e., the NIRᵢ). Accordingly, when the calculated NIRᵢ (i.e., 0.75 megabits per second) is compared 104 to the target bandwidth requirement (e.g., 1.00 megabits per second), the comparison would fail and parameter modification system 10 may adjust 106 the bandwidth distribution parameter (i.e. p₄) associated with wireless coupling 30 to set the bandwidth transmission rate (NIRᵢ) essentially equal to the target bandwidth requirement. For example, since the reduction in link quality resulted in adjustment 100 of modulations schemes from 64-QAM (¾) modulation to BPSK (½) modulation, more tones are required to transmit the same amount of data. Accordingly, bandwidth distribution parameter (i.e. p₄) may be adjusted 106 upward to apportion more tones per second to wireless coupling 30, thus allowing the bandwidth transmission rate (NIRᵢ) to be set essentially equal to the target bandwidth requirement. Accordingly, by increasing the bandwidth distribution parameter (i.e. p₄) of wireless coupling 30 from 15% to 20% (i.e., from 1.50 megatones per second to 2.00 megatones per second), the data transfer rate of wireless coupling 30 may be increased to 1.00 megabits per second (i.e., 2.00 megatones per second/2.00 tones per megabit).

Parameter modification system 10 may sum 108 the plurality of bandwidth distribution parameters (i.e., p₁, p₂, p₃, p₄) to define a utilization factor for the air link. For example, since the bandwidth distribution parameter p₄ for wireless coupling 30 was adjusted from 15% to 20%, the utilization factor for the air link is 105% (i.e., 25%+25%+35%+20%). Accordingly, the air link established by wireless access point 12 is over utilized. Therefore, parameter modification system 10 may reduce 110 one or more of the bandwidth distribution parameters to achieve a utilization factor of less than or equal to 100%. For example, the bandwidth distribution parameter for wireless coupling 28 (i.e., bandwidth distribution parameter p₃) may be reduced from 35% to 30% (thus achieving a utilization factor of 100%). Typically, the wireless coupling to be reduced 110 is chosen based on criticality of the coupling. For example, wireless couplings that are highly sensitive to data latency may be less likely to have their bandwidth distribution parameters reduced 110. Alternatively, a plurality (or all) of the wireless coupling may be equally reduced 110 to lower the utilization factor of the air link to 100% or less.

A number of implementations have been described. Nevertheless, it will be understood that various modifications may be made. Accordingly, other implementations are within the scope of the following claims.

What is claimed is:

1. A method comprising:
adjusting a conversion parameter (C^{ss}ᵢ) associated with an individual user of a multi-user air link in response to, at least in part, a variation in the transmission quality of the air link;
determining a bandwidth transmission rate (NIRᵢ) for the individual user of the multi-user air link, wherein the bandwidth transmission rate (NIRᵢ) is dependant upon the conversion parameter (C^{ss}ᵢ) associated with the individual user and a bandwidth distribution parameter (pᵢ) associated with the individual user;
comparing the bandwidth transmission rate (NIRᵢ) with a target bandwidth requirement for the individual user of the multi-user air link; and
adjusting the bandwidth distribution parameter (pᵢ) associated with the individual user to set the bandwidth transmission rate (NIRᵢ) essentially equal to the target bandwidth requirement.

2. The method of claim 1 wherein the conversion parameter (C^{ss}ᵢ) defines the number of tones required to transmit one unit of data, and the bandwidth transmission rate (NIRᵢ) defines the number of units of data to be transmitted per unit time.

3. The method of claim 1 wherein the bandwidth distribution parameter (pᵢ) associated with the individual user is essentially equal to the product of the conversion parameter (C^{ss}ᵢ) associated with the individual user and the bandwidth transmission rate (NIRᵢ) determined for the individual user divided by a total bandwidth capacity of the air link.

4. The method of claim 1 wherein:
the individual user is one of a plurality of users; and
each of the plurality of users is assigned one of a plurality of bandwidth distribution parameters (pᵢ).

5. The method of claim 4 further comprising:
summing the plurality of bandwidth distribution parameters to define a utilization factor for the multi-user air link.

6. The method of claim 5 further comprising:
reducing one or more of the plurality of bandwidth distribution parameters (pᵢ) to reduce the utilization factor to less than or equal to 100%.

7. A computer program product residing on a computer readable medium having a plurality of instructions stored thereon which, when executed by a processor, cause the processor to perform operations comprising:
adjusting a conversion parameter (C^{ss}ᵢ) associated with an individual user of a multi-user air link in response to, at least in part, a variation in the transmission quality of the air link;
determining a bandwidth transmission rate (NIRᵢ) for the individual user of the multi-user air link, wherein the bandwidth transmission rate (NIRᵢ) is dependant upon the conversion parameter (C^{ss}ᵢ) associated with the individual user and a bandwidth distribution parameter (pᵢ) associated with the individual user;
comparing the bandwidth transmission rate (NIRᵢ) with a target bandwidth requirement for the individual user of the multi-user air link; and
adjusting the bandwidth distribution parameter (pᵢ) associated with the individual user to set the bandwidth transmission rate (NIRᵢ) essentially equal to the target bandwidth requirement.

8. The computer program product of claim 7 wherein the conversion parameter (C^{ss}ᵢ) defines the number of tones required to transmit one unit of data, and the bandwidth transmission rate (NIRᵢ) defines the number of units of data to be transmitted per unit time.

9. The computer program product of claim 7 wherein the bandwidth distribution parameter (pᵢ) associated with the individual user is essentially equal to the product of the conversion parameter (C^{ss}ᵢ) associated with the individual user and the bandwidth transmission rate (NIRᵢ) determined for the individual user divided by a total bandwidth capacity of the air link.

10. The computer program product of claim 7 wherein:
the individual user is one of a plurality of users; and
each of the plurality of users is assigned one of a plurality of bandwidth distribution parameters (pᵢ).

11. The computer program product of claim 10 further comprising instructions for:
summing the plurality of bandwidth distribution parameters to define a utilization factor for the multi-user air link.

12. The computer program product of claim 11 further comprising instructions for:
reducing one or more of the plurality of bandwidth distribution parameters (pᵢ) to reduce the utilization factor to less than or equal to 100%.

13. An electronic device configured for:
adjusting a conversion parameter (C^{ss}ᵢ) associated with an individual user of a multi-user air link in response to, at least in part, a variation in the transmission quality of the air link;
determining a bandwidth transmission rate (NIRᵢ) for the individual user of the multi-user air link, wherein the bandwidth transmission rate (NIRᵢ) is dependant upon the conversion parameter (C^{ss}ᵢ) associated with the individual user and a bandwidth distribution parameter (pᵢ) associated with the individual user;
comparing the bandwidth transmission rate (NIRᵢ) with a target bandwidth requirement for the individual user of the multi-user air link; and
adjusting the bandwidth distribution parameter (pᵢ) associated with the individual user to set the bandwidth transmission rate (NIRᵢ) essentially equal to the target bandwidth requirement.

14. The electronic device of claim 13 wherein the conversion parameter (C^{ss}ᵢ) defines the number of tones required to transmit one unit of data, and the bandwidth transmission rate (NIRᵢ) defines the number of units of data to be transmitted per unit time.

15. The electronic device of claim 13 wherein the bandwidth distribution parameter (pᵢ) associated with the individual user is essentially equal to the product of the conversion parameter (C^{ss}ᵢ) associated with the individual user and the bandwidth transmission rate (NIRᵢ) determined for the individual user divided by a total bandwidth capacity of the air link.

16. The electronic device of claim 13 wherein:
the individual user is one of a plurality of users; and
each of the plurality of users is assigned one of a plurality of bandwidth distribution parameters (pᵢ).

17. The electronic device of claim 16, wherein the electronic device is further configured for:
summing the plurality of bandwidth distribution parameters to define a utilization factor for the multi-user air link.

18. The electronic device of claim 17, wherein the electronic device is further configured for:
reducing one or more of the plurality of bandwidth distribution parameters (pᵢ) to reduce the utilization factor to less than or equal to 100%.
